(19) United States
(12) Patent Application Publication
(10) Pub. No.: US 2018/0354319 A1
(43) Pub. Date: Dec. 13, 2018

(54) Bead-Breaker Adapter

(71) Applicant: Michael Joel Griffin, Prunedale, CA (US)

(72) Inventor: Michael Joel Griffin, Prunedale, CA (US)

(21) Appl. No.: 15/621,353

(22) Filed: Jun. 13, 2017

(51) Int. Cl. B60C 25/02

(52) U.S. Cl. CPC B60C 25/02; B60C 2200/10

(57) ABSTRACT

A bead-breaker adapter is an apparatus that minimizes the amount of force a user needs use in order to separate a tire from a wheel. The apparatus includes a spacing tube, a first extension arm, an axle-receiving hole, a bead-breaker handlebar, a second extension arm, and a wedge. The spacing tube attaches the apparatus onto a tire stand. The spacing tube allows the first extension arm to rotate about the axle of a tire stand and upholds the first extension arm above a tire mounted onto the tire stand via the axle-receiving hole. The first extension arm connects the bead-breaker handlebar to the axle of the tire stand and allows the bead-breaker handlebar to vertically pivot about the tire. The second extension arm connects the wedge to the bead-breaker handlebar and laterally pivots about the tire so that the wedge may be properly leveraged between the wheel and the tire.

### FIELD OF THE INVENTION

The present invention relates generally to bead-breaker adapters. More specifically, the present invention is an accessory for existing tire stands that both mounts a tire onto a tire stand and alleviates the force needed to separate the tire from the wheel.

### BACKGROUND OF THE INVENTION

Motorcycle maintenance is a physically demanding task that must be regularly conducted. Due to the high cost of motorcycle maintenance, motorcyclists typically perform their own maintenance. Unless the motorcyclist is experienced or professionally trained, the motorcycle may get damaged or the parts of the motorcycle may not be properly installed and the safety of the motorcyclist is at risk.

The present invention serves to facilitate one of the most physically demanding aspects of motorcycle maintenance, which is changing of tires. The present invention utilizes existing tire stands and provides the necessary leverage so that the user uses the least amount of force to separate the tire from the wheel. The present invention does not come into contact with the wheel and does not scratch or damage the wheel as existing tire spoons or mounting tools do. The present invention incorporates a bead breaker that aids in the mounting of a tire to a tire stand while changing the tire.

### BRIEF DESCRIPTION OF THE DRAWINGS

FIG. 1 is a perspective view of the preferred embodiment of the present invention.

FIG. 2 is a front side view of the preferred embodiment of the present invention.

FIG. 3 is a perspective view of the tire mounting and removal system of the present invention, wherein the gripping clamp is mounted about the spacing tube by the slideable bracket.

FIG. 4 is a perspective view of the gripping clamp of the present invention.

FIG. 5 is a top side view of the gripping clamp of the present invention.

FIG. 6 is a cross-sectional view of FIG. 5 along line 6-6 of the gripping clamp of the present invention.

### DETAILED DESCRIPTION OF THE INVENTION

All illustrations of the drawings are for the purpose of describing selected versions of the present invention and are not intended to limit the scope of the present invention.

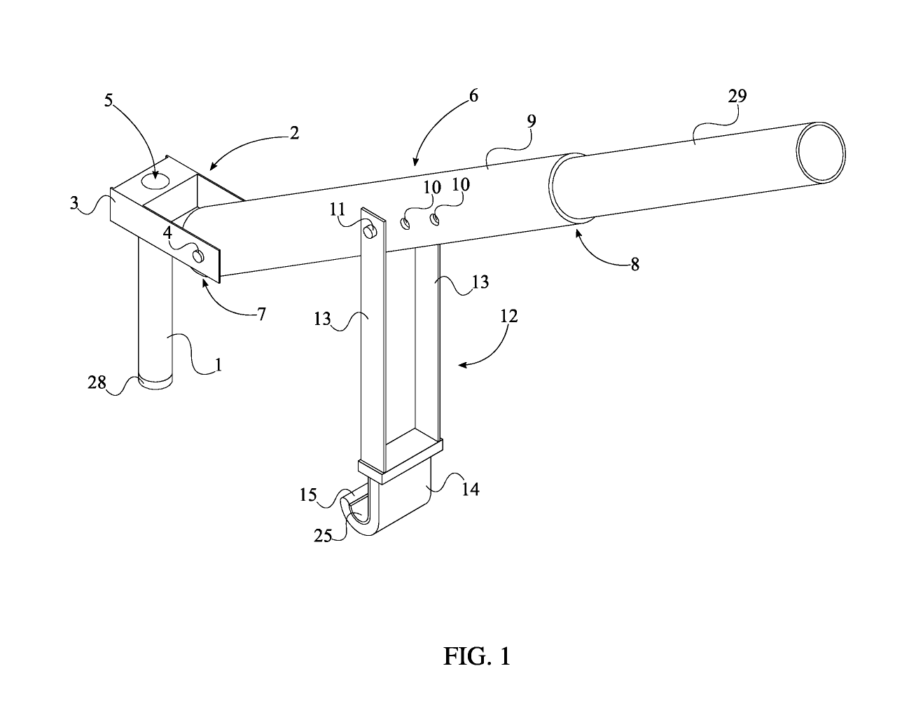

The present invention is a bead-breaker adapter that facilitates the changing of tires, specifically motorcycle tires. The bead-breaker adapter is mounted onto an existing tire stand and may be mounted onto a variety of tire stands. The present invention provides the necessary leverage to alleviate the user from using excessive force against the tire which may result in the damaging of a corresponding wheel. As shown in FIG. 1, the present invention comprises a spacing tube 1, a first extension arm 2, an axle-receiving hole 5, a bead-breaker handlebar 6, a second extension arm 12, and a wedge 14. The spacing tube 1 upholds the first extension arm 2 above a tire mounted onto a tire stand so that the bead-breaker handlebar 6 may freely rotate about the first extension arm 2. The first extension arm 2 connects the bead-breaker handlebar 6 to the tire stand and allows the bead-breaker handlebar 6 to uniformly rotate about the axle of the tire stand. The axle-receiving hole 5 allows the first extension arm 2 to be mounted onto the axle of a tire stand. The bead-breaker handlebar 6 allows a user to maneuver the wedge 14 against the tire. The bead-breaker handlebar 6 further comprises a fixed end 7 and a free end 8 so that the user may raise and lower the second extension arm 12 and the wedge 14 about the axle of the tire stand. The raising and lowering of the bead-breaker handlebar 6 forces the wedge 14 towards and away from the tire. The second extension arm 12 connects the wedge 14 to the bead-breaker handlebar 6. The wedge 14 directly pushes against the tire without coming into contact with or damages the wheel.

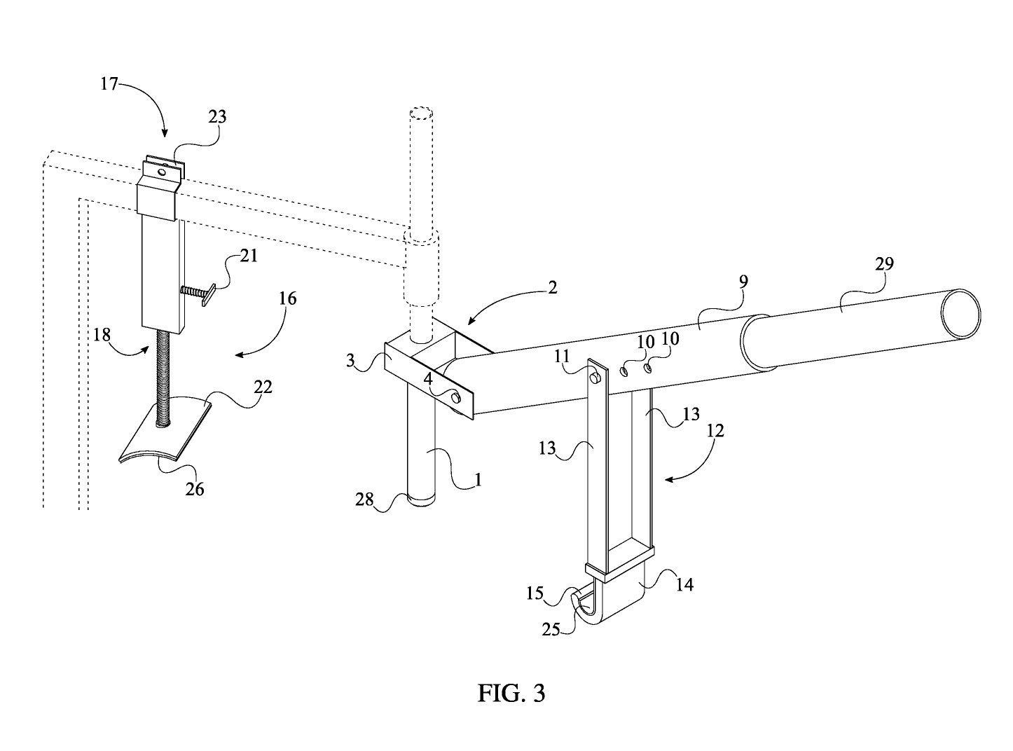

The overall configuration of the aforementioned components allows the present invention to be attached to a variety of tire stands and minimize the force needed to separate a tire from a wheel. The first extension arm 2 is terminally and perpendicularly positioned to the spacing tube 1 so that the first extension arm 2 may rest on the spacing tube 1 and is distanced from the wheel. As seen in FIG. 1 and FIG. 3, the axle-receiving hole 5 traverses through the first extension arm 2 and is concentrically positioned to the spacing tube 1 so that the axle of the tire stand freely traverses through the spacing tube 1 and the first extension arm 2. The fixed end 7 of the bead-breaker handlebar 6 is terminally and hingedly connected to the first extension arm 2, thereby providing the necessary leverage for the user as the bead-breaker handlebar 6 is raised and lowered. The second extension arm 12 is laterally and hingedly attached to the bead-breaker handlebar 6 so that the wedge 14 may pivot towards and away from the rim of the tire along the wheel. The wedge 14 is terminally connected to the second extension arm 12, opposite to the bead-breaker handlebar 6 so that the wedge 14 may come into direct contact with the tire as maneuvered by the vertical and lateral movements of the first extension arm 2 and the second extension arm 12.

The first extension arm 2 further comprises a first clevis 3 and a first tang 4 in order to provide uphold the bead-breaker handlebar 6 and support the pivoting movement of the bead-breaker handlebar 6. As seen in FIG. 3, the first clevis 3 mounts the first extension arm 2 onto the axle of the tire stand. The first tang 4 connects the bead-breaker handlebar 6 to the first clevis 3. The first tang 4 is connected across the first clevis 3 and is positioned opposite to the axle-receiving hole 5 along the first clevis 3 so that the bead-breaker handlebar 6 may rotate freely while remaining attached to the first clevis 3. More specifically, the tang 4 and the axle-receiving hole 5 are oriented perpendicular to each other so that the bead-breaker handlebar 6 may vertically pivot with respect to the axle of the tire stand as the first clevis 3 may laterally pivot about the axle of the tire stand. Furthermore, the fixed end 7 is rotatably connected to the first tang 4 in order for the second extension arm 12 to be raised and lowered by the bead-breaker handlebar 6.

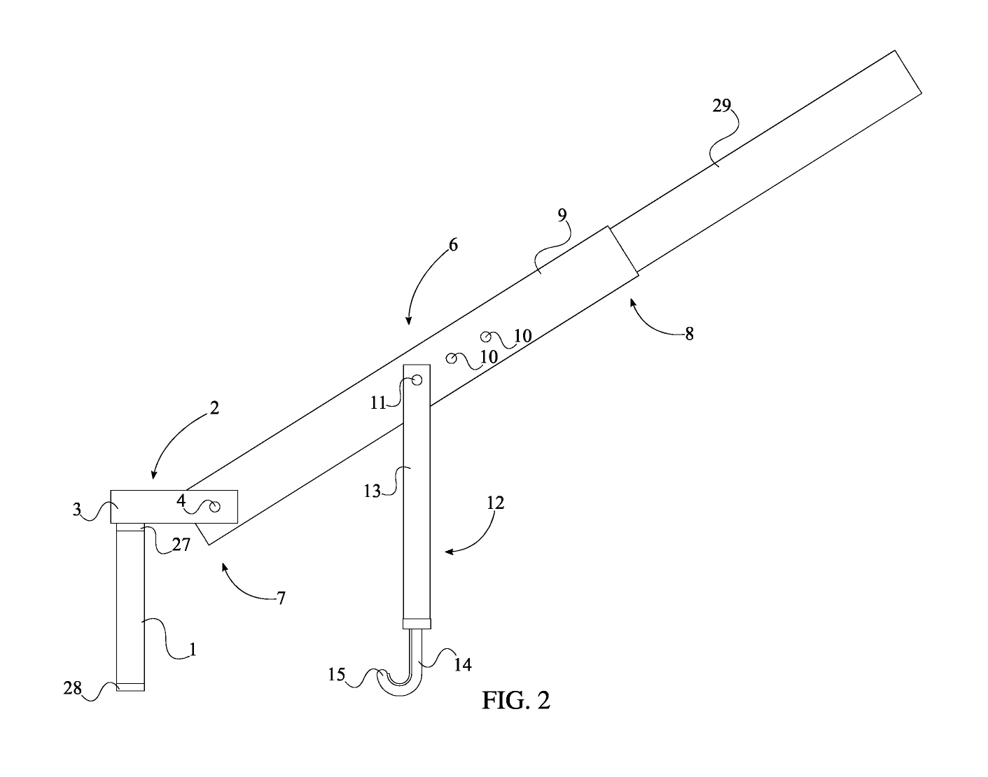

As illustrated in FIG. 2, the bead-breaker handlebar 6 further comprises a bar body 9, a plurality of locking holes 10, and a locking pin 11. The bar body 9 allows a user to maneuver the bead-breaker handlebar 6 and consequently the second extension arm 12. The plurality of locking holes 10 allows a user to mount the second extension arm 12 at varying distances from the axle of the tire stand in order to accommodate the tires of varying sizes. The locking pin 11 secures the second extension arm 12 to a specific locking hole. The plurality of locking holes 10 laterally traverses through the bar body 9 to accommodate the lateral movement of the second extension arm 12. The plurality of locking holes 10 is distributed along the bar body 9 in order to accommodate various sized tires. The locking pin 11 engages a desired hole from the plurality of locking holes 10, and the second extension arm 12 is rotatably connected to the locking pin 11 so that the second extension arm 12 remains connected to the bar body 9.

In order to further lessen the amount of force applied by a user against the bead-breaker handlebar 6, an elongated torque increaser 29 is slidably engaged to the bead-breaker handlebar 6. The elongated torque increaser 29 is preferably a rod or tube that traverses into the bead-breaker handlebar 6, as seen in FIG. 1 and FIG. 2. In order for the user to maneuver the elongated torque increaser 29, the elongated torque increaser 29 traverses into the bead-breaker handlebar 6, opposite to the first extension arm 2. As the elongated torque increaser 29 is lowered and traverses into the bead-breaker handlebar 6, maximizing the force against the tire via the wedge 14. In a preferred embodiment of the present invention, a gripping sleeve 19 may surround the elongated torque increaser 29, positioned exterior to the bead-breaker handlebar 6 so that the user may comfortable and securely grip the elongated torque increaser 29.

In order for the second extension arm 12 to provide the necessary structural integrity, the second extension arm 12 comprises a pair of rods 13, as illustrated in FIG. 1. The pair of rods 13 supports the applied force and the movement of the second extension arm 12 against the tire while limiting the amount of force required to lift the bead-breaker handlebar 6. The pair of rods 13 is positioned parallel and offset from each other so that the force of both the bead-breaker handlebar 6 and the wedge 14 is equally distributed across the pair of rods 13. The bead-breaker handlebar 6 is rotatably and terminally connected in between the pair of rods 13. This configuration of the pair of rods 13 about the bead-breaker handlebar 6 accommodates the change in position of the second extension arm 12 along the bead-breaker handlebar 6 and lateral movement of the second extension arm 12. Consequently, the wedge 14 is terminally connected to the pair of rods 13, opposite to the bead-breaker handlebar 6 in order for the wedge 14 to come into direct contact with the tire.

In the preferred embodiment of the present invention, a leveraging claw 15 may provide better leverage between the wheel and the rim of the tire. The leveraging claw 15, as seen in FIG. 2, is laterally connected to the wedge 14 so that the leveraging claw 15 comes is positioned in between the wheel and the rim of the tire upon contact with the tire. The leveraging claw 15 and the second extension arm 12 is positioned offset to each other along the wedge 14 so that the leveraging claw 15 may hook under the wheel and the wedge 14 may press against the tire, thereby separating the tire from the wheel without damaging the wheel. More, specifically, the leveraging claw 15 is oriented towards the spacing tube 1 as the spacing tube 1 is aligned with the center of the tire. This configuration aligns the leveraging claw 15 between the rim and the tire, and therefore allows the leveraging claw 15 to grasp onto the rim while pushing against the tire. In order to better leverage the wedge 14, a first friction-inducing layer 25 is mounted onto the wedge 14, opposite to the extension arm.

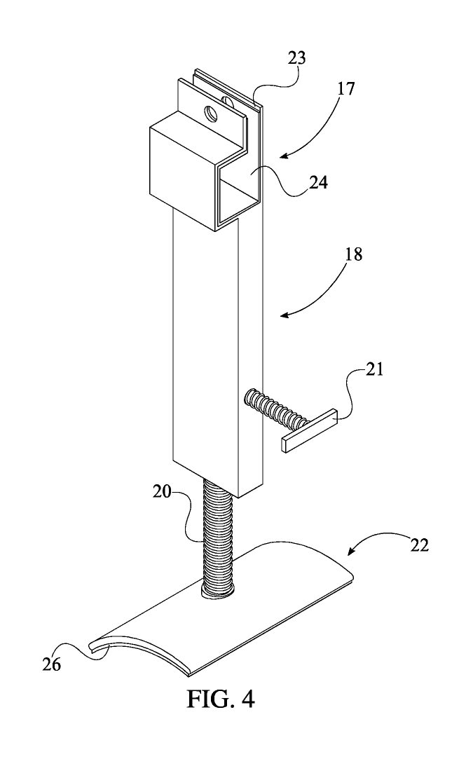

In the preferred embodiment of the present invention, a gripping clamp 16 connects the tire to the tire stand and, more importantly, secures the position of the tire about the axles of the tire stand. The gripping clamp 16 prevents the tire from spinning as the wedge 14 comes into contact with the tire, thereby eliminating the task of manually holding the tire in place. As illustrated in FIG. 4, the gripping clamp 16 comprises a slideable bracket 17, a telescopic strut 18 and a tire-bracing press 22. The slideable bracket 17 attaches the gripping clamp 16 to the tire stand, as shown in FIG. 3. The telescopic strut 18 connects the tire-bracing press 22 to the slideable bracket 17 and allows the user to adjust the distance between the tire-bracing press 22 and the tire stand in order to accommodate tires of various thicknesses. The tire-bracing press pushes against a tire and prevents the tire from spinning upon the engagement of the leveraging claw 15 against the rim of the tire. The gripping clamp 16 is mounted about the spacing tube 1 by the slideable bracket 17 so that the position of the tire-bracing press 22 is fixed about the center of the tire. Consequently, the telescopic strut 18 is radially offset from the spacing tube 1 as the tire-bracing press 22 is attached to the slideable bracket 17 by the spacing tube 1. More specifically, the slideable bracket 17 is terminally connected to the telescopic strut 18, and the tire-bracing press 22 is terminally connected to the telescopic strut 18, opposite to the slideable bracket 17.

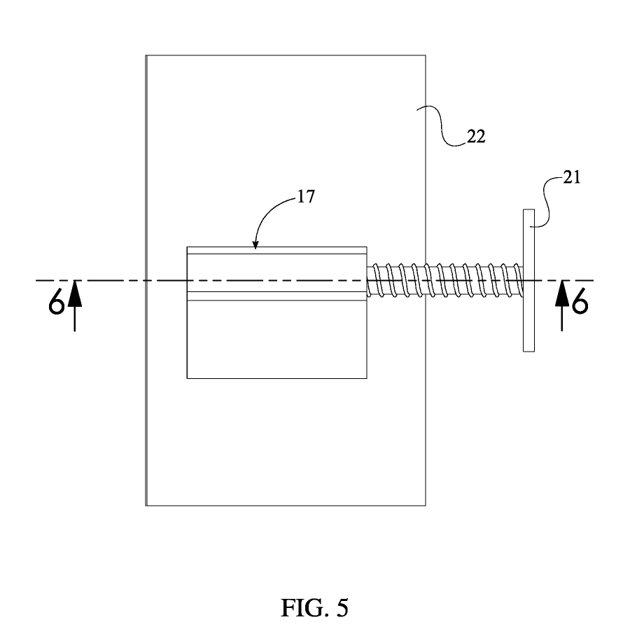

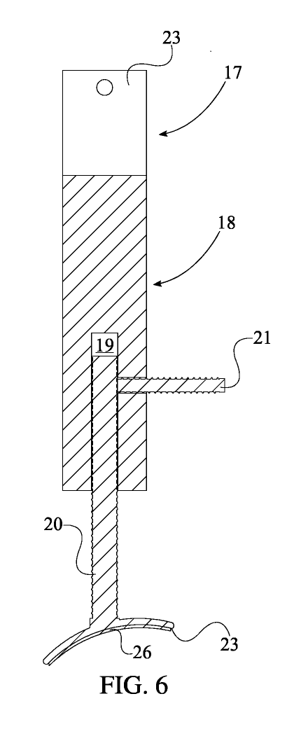

In order to vary the distance between the slideable bracket 17 and the tire-bracing press 22, the telescopic strut 18 comprises a sleeve 19, a rod 20, and a tension-locking mechanism 21. As seen in the cross-sectional view of FIG. 6, the sleeve 19 houses the rod 20, and the rod 20 lengthens and shortens the distance between the slideable bracket 17 and the tire-bracing press 22. The tension-locking mechanism 21 secures the position of the rod 20 within the sleeve 19. In order for the rod 20 to readily traverse into and out of the sleeve 19, the slideable bracket 17 is terminally connected to the sleeve 19. More specifically, the rod 20 traverses into the sleeve 19, opposite to the slideable bracket 17, and the tire-bracing press 22 is terminally connected to the rod 20, opposite to the sleeve 19, so that the tire-bracing press 22 may come into contact with the tire. The tension-locking mechanism 21 is operatively integrated between the sleeve 19 and the rod 20, wherein the tension-locking mechanism 21 is used to adjust the overall length between the sleeve 19 and the rod 20. The tension-locking mechanism 21 is preferably a rigid bar that is oriented perpendicular to the rod 20 and traverses into the sleeve 19, as seen in FIG. 4 and FIG. 5. The rigid bar presses against the rod 20 in order secure the position of the rod 20 within sleeve 19. Preferably, a handlebar is terminally fixed to the rigid bar, positioned exterior to the sleeve 19 so that a user may easily maneuver the rigid bar.

In the preferred embodiment of the present invention, a second friction-inducing layer 26 is mounted across the tire-bracing press, opposite to the rod. The second friction-inducing layer 26 increases the friction between the between the tire-bracing press 22 and a tire. Moreover, the second friction-inducing layer 26 prevents the tire from sliding or spinning as the leveraging claw 15 presses against the tire.

In order to further secure the tire-bracing press 22 onto the tire, the slideable bracket 17 comprises an engagement surface 23 and a third friction-inducing layer 24. The engagement surface 23 engages the arm of the tire stand and the third friction-inducing layer 24 increases the friction between the engagement surface 23 and the arm of the tire stand. The third friction-inducing layer 24 is superimposed onto the engagement surface 23, thereby reinforcing the position of the slideable bracket 17 along the arm of the tire stand.

The preferred embodiment of the present invention may further comprise a first collar 27 and a second collar 28, as seen in FIG. 2. The first collar 27 and the second collar 28 relieve the stress of the rotation of the spacing tube 1 about the axle of the tire stand. The first collar 27 is positioned in between the first extension arm 2 and the spacing tube 1 in order to prevent the grinding of the spacing tube 1 against the first extension arm 2. The second collar 28 is terminally positioned adjacent the spacer tube, opposite to the first collar 27, in order to prevent the grinding of the spacing tube 1 against the tire stand. More specifically, the first collar 27 and the second collar 28 are concentrically positioned with the axle-receiving hole 5, as the axle of the tire stand traverses through the first collar 27, the axle-receiving hole 5, the spacing tube 1, and the second collar 28.

Although the invention has been explained in relation to its preferred embodiment, it is to be understood that many other possible modifications and variations can be made without departing from the spirit and scope of the invention as hereinafter claimed.

What is claimed is:

1. A bead-breaker adapter comprises:
a spacing tube;
a first extension arm;
an axle-receiving hole;
a bead-breaker handlebar;
a second extension arm;
a wedge;
the bead-breaker handlebar comprises a fixed end and a free end;
the first extension arm being terminally and perpendicularly positioned to the spacing tube;
the axle-receiving hole traversing through the first extension arm;
the axle-receiving hole being concentrically positioned to the spacing tube;
the fixed end being terminally and hingedly connected to the first extension arm;
the second extension arm being laterally and hingedly attached to the bead-breaker handlebar; and
the wedge being terminally connected to the second extension arm, opposite to the bead-breaking handlebar.

2. The bead-breaker adapter as claimed in claim 1 comprises:
the first extension arm comprises the first clevis and a first tang;
the tang being connected across the first clevis;
the tang and the axle-receiving hole being positioned opposite to each other along the first clevis;
the tang and the axle-receiving hole being oriented perpendicular to each other; and
the fixed end being rotatably connected to the first tang.

3. The bead-breaker adapter as claimed in claim 1 comprises:
the bead-breaker handlebar further comprises a bar body, a plurality of locking holes, and a locking pin;
the plurality of locking holes laterally traversing through the bar body;
the plurality of locking holes being distributed along the bar body;
the locking pin engaging a desired hole from the plurality of locking holes; and
the second extension arm being rotatably connected to the locking pin.

4. The tire mounting and removal system as claimed as claim 1 comprises:
an elongated torque increaser;
the elongated torque increaser being slidably engaged to the bead-breaker handlebar; and
the elongated torque increaser traversing into the bead-breaker handlebar, opposite to the first extension arm.

5. The bead-breaker adapter as claimed in claim 1 comprises:
the second extension arm comprises a pair of rods;
the pair of rods being positioned parallel and offset from each other;
the bead-breaker handlebar being rotatably and terminally connected in between the pair of rods; and
the wedge being terminally connected to the pair of rods, opposite to the bead-breaker handlebar.

6. The bead-breaker adapter as claimed in claim 1 comprises:
a leveraging claw;
the leveraging claw being laterally connected to the wedge;
the leveraging claw and the second extension arm being positioned offset to each other along the wedge; and
the leveraging claw being oriented towards the spacing tube.

7. The tire mounting and removal system as claimed as claim 1 comprises:
a first friction-inducing layer; and
the first friction-inducing layer being mounted onto the wedge, opposite to the second extension arm.

8. The bead-breaker adapter as claimed in claim 1 comprises:
a gripping clamp;
the gripping clamp comprises a slideable bracket, a telescopic strut, and a tire-bracing press;
the gripping clamp being mounted about the spacing tube by the slideable bracket;
the telescopic strut being radially offset from the spacing tube;
the slideable bracket being terminally connected to the telescopic strut; and
the tire-bracing press being terminally connected to the telescopic strut, opposite to the slideable bracket.

9. The bead-breaker adapter as claimed in claim 8 comprises:
the telescopic strut comprises a sleeve, a rod, and a tension-locking mechanism;
the slideable bracket being terminally connected to the sleeve;
the rod traversing into the sleeve, opposite to the slideable bracket;
the tire-bracing press being terminally connected to the rod, opposite to the sleeve; and
the tension-locking mechanism being operatively integrated between the sleeve and the rod, wherein the tension-locking mechanism is used to adjust an overall length between the sleeve and the rod.

10. The tire mounting and removal system as claimed as claim 8 comprises:
a second friction-inducing layer; and
the second friction-inducing layer being mounted across the tire-bracing press, opposite to the rod.

11. The tire mounting and removal system as claimed as claim 8 comprises:
the slideable bracket comprises an engagement surface and a third friction-inducing layer; and
the third friction-inducing layer being superimposed onto the engagement surface.

12. The tire mounting and removal system as claimed as claim 1 comprises:
a first collar;
a second collar;
the first collar being positioned in between the first extension arm and the spacing tube;
the second collar being terminally positioned adjacent the spacer tube, opposite to the first collar; and
the first collar and the second collar being concentrically positioned with the axle-receiving hole.

13. A bead-breaker adapter comprises:
a spacing tube;
a first extension arm;
an axle-receiving hole;
a bead-breaker handlebar;
a second extension arm;
a wedge;
an elongated torque increaser;
a leveraging claw;
a gripping clamp;
the bead-breaker handlebar comprises a fixed end and a free end;
the gripping clamp comprises a slideable bracket, a telescopic strut, and a tire-bracing press;
the first extension arm being terminally and perpendicularly positioned to the spacing tube;
the axle-receiving hole traversing through the first extension arm;
the axle-receiving hole being concentrically positioned to the spacing tube;
the fixed end being terminally and hingedly connected to the first extension arm;
the second extension arm being laterally and hingedly attached to the bead-breaker handlebar;
the wedge being terminally connected to the second extension arm, opposite to the bead-breaking handlebar;
the elongated torque increaser being slidably engaged to the bead-breaker handlebar;
the elongated torque increaser traversing into the bead-breaker handlebar, opposite to the first extension arm;
the leveraging claw being laterally connected to the wedge;
the leveraging claw and the second extension arm being positioned offset to each other along the wedge; and
the leveraging claw being oriented towards the spacing tube.
the gripping clamp being mounted about the spacing tube by the slideable bracket;
the telescopic strut being radially offset from the spacing tube;
the slideable bracket being terminally connected to the telescopic strut; and
the tire-bracing press being terminally connected to the telescopic strut, opposite to the slideable bracket.

14. The bead-breaker adapter as claimed in claim 13 comprises:
the first extension arm comprises the first clevis and a first tang;
the tang being connected across the first clevis;
the tang and the axle-receiving hole being positioned opposite to each other along the first clevis;
the tang and the axle-receiving hole being oriented perpendicular to each other; and
the fixed end being rotatably connected to the first tang.

15. The bead-breaker adapter as claimed in claim 13 comprises:
the bead-breaker handlebar further comprises a bar body, a plurality of locking holes, and a locking pin;
the plurality of locking holes laterally traversing through the bar body;
the plurality of locking holes being distributed along the bar body;
the locking pin engaging a desired hole from the plurality of locking holes; and
the second extension arm being rotatably connected to the locking pin.

16. The bead-breaker adapter as claimed in claim 13 comprises:
the second extension arm comprises a pair of rods;
the pair of rods being positioned parallel and offset from each other;
the bead-breaker handlebar being rotatably and terminally connected in between the pair of rods; and
the wedge being terminally connected to the pair of rods, opposite to the bead-breaker handlebar.

17. The tire mounting and removal system as claimed as claim 13 comprises:
a first friction-inducing layer; and
the first friction-inducing layer being mounted onto the wedge, opposite to the second extension arm.

18. The bead-breaker adapter as claimed in claim 13 comprises:
the telescopic strut comprises a sleeve, a rod, and a tension-locking mechanism;
the slideable bracket being terminally connected to the sleeve;
the rod traversing into the sleeve, opposite to the slideable bracket;
the tire-bracing press being terminally connected to the rod, opposite to the sleeve; and
the tension-locking mechanism being operatively integrated between the sleeve and the rod, wherein the tension-locking mechanism is used to adjust an overall length between the sleeve and the rod.

19. The tire mounting and removal system as claimed as claim 13 comprises:
a second friction-inducing layer;
the slideable bracket comprises an engagement surface and a third friction-inducing layer;
the second friction-inducing layer being mounted across the tire-bracing press, opposite to the rod; and
the third friction-inducing layer being superimposed onto the engagement surface.

20. The tire mounting and removal system as claimed as claim 13 comprises:
a first collar;
a second collar;
the first collar being positioned in between the first extension arm and the spacing tube;
the second collar being terminally positioned adjacent the spacer tube, opposite to the first collar; and
the first collar and the second collar being concentrically positioned with the axle-receiving hole.
